(19) United States
(12) Patent Application Publication
(10) Pub. No.: US 2009/0024612 A1
(43) Pub. Date: Jan. 22, 2009

(54) FULL TEXT QUERY AND SEARCH SYSTEMS AND METHODS OF USE

(75) Inventors: Yuanhua Tang, San Jose, CA (US); Qianjin Hu, Castro Valley, CA (US); Yonghong Yang, San Jose, CA (US)

Correspondence Address: HAYNES BEFFEL & WOLFELD LLP, P O BOX 366, HALF MOON BAY, CA, 94019, US

(73) Assignee: INFOVELL, INC., Menlo Park, CA (US)

(21) Appl. No.: 12/029,259

(22) Filed: Feb. 11, 2008

Related U.S. Application Data
(62) Division of application No. 11/259,468, filed on Oct. 25, 2005.
(60) Provisional application No. 60/621,616, filed on Oct. 25, 2004.
(60) Provisional application No. 60/681,414, filed on May 16, 2005.

(51) Int. Cl. G06F 17/30

(52) U.S. Cl. 707/5; 707/E17.015

(57) ABSTRACT

The invention is a method for textual searching of text-based databases including databases of compiled internet content, scientific literature, abstracts for books and articles, newspapers, journals, and the like. Specifically, the algorithm supports searches using full-text or webpage as query and keyword searches allowing multiple entries and an information-content based ranking system (Shannon Information score) that uses p-values to represent the likelihood that a hit is due to random matches. Additionally, users can specify the parameters that determine hits and their ranking with scoring based on phrase matches and sentence similarities.

### RELATED APPLICATIONS

This is a Divisional of U.S. patent application Ser. No. 11/259,468, filed Oct. 25, 2005, which claims the benefit of U.S. provisional application 60/621,616 filed 25 Oct. 2004 entitled “Search engines for textual databases with full-text query” and U.S. provisional application 60/681,414 filed 16 May 2005 entitled “Full text query and search methods”, both herein incorporated by reference in their entirety.

### TECHNICAL FIELD

The invention encompasses the fields of information technology and software and relates to methods for ranked informational retrieval from text-based databases.

### BACKGROUND ART

Traditional online computer-based search methods of text content databases are mostly keyword based, that is to say, a database and its associated dictionary are first established. An index file for the database is associated with the dictionary where the occurrence of each keyword and its location within the database are recorded. When a query contains the keyword is entered, all the entries in the database containing that keyword is returned. In “advanced search” types, a user can specifying exclusion words as well, where the appearance of the specified words are not allowed to be present in any hits.

One key issue about keyword based search engines is how to rank the “hits” if there are many entries containing the word. Consider first the case of a single keyword. GOOGLE, a current internet search engine for example, uses the number of links pointing to that entry by other entries as the sorting score (ranking based on citation or reference). Thus, the more the other entries reference this entry (entry E), the higher the entry E will be in the sorted list. A search on a keyword is reduced to binary searches first locating the word in the index file and then locating the database entries that contain this word. The complete list of all entries containing that word is reported to the user in a sorted manner by citation ranking. Another method, used both by GOOGLE and by YAHOO, is to rank the hits based on an “auction” scheme between the owners of webpages: whoever pays the most for the word will have a higher score assigned to their webpage. These two methods of ranking can be implemented separately or can be mixed together to generate a weighted score.

If multiple keywords are used in the query, the above searches are performed multiple times, and the results are then processed applying a Boolean logic, typically a “join” operation where only the intersection of the two search results are selected. The ranking will be a combination of (1) how many words a “hit” contains; (2) the “hits” rank based on reference; and (3) the advertise amount paid from the owner of the “hit”.

### Limitations

One additional problem with this search method is resulting huge number of “hits” for one or a few limited keywords. This is especially troublesome when the database is large, or the media becomes inhomogeneous. Thus, traditional search engines limit the database content and size, and also limit the selection of keyword. In world-wide web searches, one is faced with very large database, and with very inhomogeneous data content. These limitations have to be removed. Yahoo at first attempted using classification, putting restrictions on data content and limit the database size for each specific category a use selects. This approach is very labor intensive, and puts a lot of burden on the users to navigate among the multitude of categories and sub categories.

Google addresses “the huge number of hits” problem by ranking the quality of each entry. For a web page database, the quality of an entry can be calculated by link number (how many other web pages referenced this site), the popularity of the website (how many visits the page has), etc. For database of commercial advertisement, quality can be determined by amount of money paid as well. Internet users are no longer burdened by having to traverse the multilayered categories or the limitation of keywords. Using any keyword, Google's search engine returns a result list that is “objectively ranked” by its algorithm.

The prior art search method has limitations:
1 ) Limitation on number of search words: the number of keywords is very limited (usually less than ten words). Usually only a few keywords can be provided by the user. In many occasions, it may be hard to completely define a subject matter of interest by a few keywords.
2) Large amounts of “hits”: that is, many irrelevant results are reported. Usually this type of search result is a huge collection of database entries, most of them completely irrelevant to the subject matter the user wants, but all of them contain the few keywords the user provides.
3) Ranking of “hits” may not fulfill the user's intention: that is, the relevant information may be within the search results however it is buried very deep in the list. There is no good sorting method to bring the most relevant result up to the front in the result list and therefore the users usually can become frustrated.

### DISCLOSURE OF THE INVENTION

The invention provides a search engine for text-based databases, the search engine comprising an algorithm that uses a query for searching, retrieving, and ranking text, words, phrases, Infotoms, or the like, that are present in at least one database. The search engine uses ranking based on Shannon information score for shared words or Infotoms between query and hits, ranking based on p-values, calculated Shannon information score, or p-value based on word or Infotom frequency, percent identity of shared words or Infotoms.

The invention also provides a text-based search engine comprising an algorithm, the algorithm comprising the steps of: i) means for comparing a first text in a query text with a second text in a text database, ii) means for identifying the shared Infotoms between them, and iii) means for calculating a cumulative score or scores for measuring the overlap of information content using a Infotom frequency distribution, the score selected from the group consisting of cumulative Shannon Information of the shared Infotoms, the combined p-value of shared Infotoms, the number of overlapping words, and the percentage of words that are overlapping.

In one embodiment the invention provides a computerized storage and retrieval system of text information for searching and ranking comprising: means for entering and storing data as a database; means for displaying data; a programmable central processing unit for performing an automated analysis of text wherein the analysis is of text, the text selected from the group consisting of full-text as query, webpage as query, ranking of the hits based on Shannon information score for shared words between query and hits, ranking of the hits based on p-values, calculated Shannon information score or p-value based on word frequency, the word frequency having been calculated directly for the database specifically or estimated from at least one external source, percent identity of shared Infotoms, Shannon Information score for shared Infotoms between query and hits, p-values of shared Infotoms, percent identity of shared Infotoms, calculated Shannon Information score or p-value based on Infotom frequency, the Infotom frequency having been calculated directly for the database specifically or estimated from at least one external source, and wherein the text consists of at least one word. In an alternative embodiment, the text consists of a plurality of words. In another alternative embodiment, the query comprises text having word number selected from the group consisting of 1-14 words, 15-20 words, 20-40 words, 40-60 words, 60-80 words, 80-100 words, 100-200 words, 200-300 words, 300-500 words, 500-750 words 750-1000 words, 1000-2000 words, 2000-4000 words, 4000-7500 words, 7500-10,000 words, 10,000-20,000 words, 20,000-40,000 words, and more than 40,000 words. In a still further embodiment, the text consists of at least one phrase. In a yet further embodiment, the text is encrypted.

In another embodiment the system comprises system as disclosed herein and wherein the automated analysis further allows repeated Infotoms in the query and assigns a repeated Infotom with a higher score. In a preferred embodiment, the automated analysis ranking is based on p-value, the p-value being a measure of likelihood or probability for a hit to the query for their shared Infotoms and wherein the p-value is calculated based upon the distribution of Infotoms in the database and, optionally, wherein the p-value is calculated based upon the estimated distribution of Infotoms in the database. In an alternative, the automated analysis ranking of the hits is based on Shannon Information score, wherein the Shannon Information score is the cumulative Shannon Information of the shared Infotoms of the query and the hit. In another alternative, the automated analysis ranking of the hit is based on percent identity, wherein percent identity is the ratio of 2*(shared Infotoms) divided by the total Infotoms in the query and the hit

In another embodiment of the system disclosed herein, counting Infotoms within the query and the hit is performed before stemming. Alternatively, counting Infotoms within the query and the hit is performed after stemming. In another alternative, counting Infotoms within the query and the hit is performed before removing common words. In yet another alternative, counting Infotoms within the query and the hit is performed after removing common words.

In a still further embodiment of the system disclosed herein ranking of the hits is based on a cumulative score, the cumulative score selected from the group consisting of on p-value, Shannon Information score, and percent identity. In one preferred embodiment, the automated analysis assigns a fixed score for each matched word and a fixed score for each matched phrase.

In a preferred embodiment of the system, the algorithm further comprises means for presenting the query text with the hit text on a visual display device and wherein the shared text is highlighted.

In another embodiment the database further comprises a list of synonymous words and phrases.

In a yet other embodiment of the system, the algorithm allows a user to input synonymous words to the database, the synonymous words being associated with a relevant query and included in the analysis. In another embodiment the algorithm accepts text as a query without soliciting a keyword, wherein the text is selected from the group consisting of an abstract, a title, a sentence, a paper, an article, and any part thereof. In the alternative, the algorithm accepts text as a query without soliciting a keyword, wherein the text is selected from the group consisting of a webpage, a webpage URL address, a highlighted segment of a webpage, and any part thereof.

In one preferred embodiment of the invention, the algorithm analyzes a word wherein the word is found in a natural language. In a preferred embodiment the language is selected from the group consisting of Chinese, French, Japanese, German, English, Irish, Russian, Spanish, Italian, Portuguese, Greek, Polish, Czech, Slovak, Serbo-Croat, Romanian, Albanian, Turkish, Hebrew, Arabic, Hindi, Urdu, Thai, Togalog, Polynesian, Korean, Viet, Laosian, Kmer, Burmese, Indonesian, Swedish, Norwegian, Danish, Icelandic, Finnish, Hungarian, and the like.

In another preferred embodiment of the invention, the algorithm analyzes a word wherein the word is found in a computer language. In a preferred embodiment, the language is selected from the group consisting of C/C++/C#, JAVA, SQL, PERL, PHP, and the like.

The invention further provides a processed text database derived from an original text database, the processed text database having text selected from the group consisting of text having common words filtered-out, words with same roots merged using stemming, a generated list of Infotoms comprising words and automatically identified phrases, a generated distribution of frequency or estimated frequency for each word, and the Shannon Information associated with each Infotom calculated from the frequency distribution.

In another embodiment of the system disclosed herein, the programmable central processing unit further comprises an algorithm that screens the database and ignores text in the database that are most likely not relevant to the query. In a preferred embodiment, the screening algorithm further comprises reverse index lookup where a query to the database quickly identifies entries in the database that contain certain words that are relevant to the query.

The invention also provides a search engine process for searching and ranking text, the process comprising the steps of i) providing the computerized storage and retrieval system as disclosed herein; ii) installing the text-based search engine in the programmable central processing unit; and iii) inputting text, the text selected from the group consisting of text, full-text, or keyword; the process resulting in a searched and ranked text in the database.

The invention also provides a method for generating a list of phrases, their distribution frequency within a given text database, and their associated Shannon Information score, the method comprising the steps of i) providing the system disclosed herein; ii) providing a threshold frequency for identifying successive words of fixed length of two words, within the database as a phrase; iii) providing distinct threshold frequencies for identifying successive words of fixed length of 3, 4, 5, 6, 7, 8, 9, 10, 11, 12, 13, 14, 15, 16, 17, 18, 19, and 20 words within the database as a phrase; iv) identifying the frequency value of each identified phrase in the text database; v) identifying at least one Infotom; and vi) adjusting the frequency table accordingly as new phrases of fixed length are identified such that the component Infotoms within an identified Infotom will not be counted multiple times, thereby generating a list of phrases, their distribution frequency, and their associated Shannon Information score.

The invention also provides a method for comparing two sentences to find similarity between them and provide similarity scores wherein the comparison is based on two or more items selected from the group consisting of word frequency, phrase frequency, the ordering of the words and phrases, insertion and deletion penalties, and utilizing substitution matrix in calculating the similarity score, wherein the substitution matrix provides a similarity score between different words and phrases.

The invention also provides a text query search engine comprising means for using the methods disclosed herein, in either full-text as query search engine or webpage as query search engine.

The invention further provides a user interface that displays the data identified using the algorithm disclosed herein, the display being presented using display means selected from the group consisting of a webpage, a graphical user interface, a touch-screen interface, and internet connecting means and where the internet connecting means are selected from the group consisting of broadband connection, ethernet connection, telephonic connection, wireless connection, and radio connection.

The invention also provides a search engine comprising the system disclosed herein, the database disclosed herein, the search engine disclosed herein, and the user interface, further comprising a hit, the hit selected from the group consisting of hits ranked by website popularity, ranked by reference scores, and ranked by amount of paid advertisement fees. In a preferred embodiment, the algorithm further comprises means for re-ranking search results from other search engines using Shannon Information for the database text or Shannon Information for the overlapped words. In another preferred embodiment, the algorithm further comprises means for re-ranking search results from other search engines using a p-value calculated based upon the frequency distribution of Infotoms within the database or based upon the frequency distribution of overlapped Infotoms.

The invention also provides a method for calculating the Shannon Information for the repeated Infotoms in query and in hit, the method comprising the step of calculating the score S using the equation S=min(n,m)*S_{w}, wherein S_{w} is the Shannon Information of the Infotom and wherein the number of times a shared Infotom is in the query is m and the number of times the shared Infotom is in the hit is n.

The invention further provides a method for ranking advertisements using the full-text search engine disclosed herein, the search engine process disclosed herein, the Shannon Information score, and the method for calculating the Shannon Information disclosed above, the method further comprising the step of creating an advertisement database. In a preferred embodiment, the method for ranking the advertisement further comprises the step of outputting the ranking to a user via means selected from the group consisting of a user interface and an electronic mail notification.

In another embodiment, the invention provides a method for charging customers using the methods of ranking advertisements and that is based upon the word count in the advertisement and the number of links clicked by customers to the advertiser's site.

In another embodiment the invention provides a method for re-ranking the outputs from a second search engine, the method further comprising the steps of i) using a hit form the second search engine as a query; and ii) generating a re-ranked hit using the method for claim 26, wherein the searched database is limited to all the hits that had been returned by the second search engine.

The invention also provides a user interface as disclosed above that further comprised a first virtual button in virtual proximity to at least one hit and wherein when the first virtual button is clicked by a user, the search engine uses the hit as a query to search the entire database again resulting in a new result page based on that hit as query. In another alternative, the user interface further comprises a second virtual button in virtual proximity to at least one hit and wherein when the second virtual button is clicked by a user, the search engine uses the hit as a query to re-rank all of the hits in the collection resulting in a new result page based on that hit as query. In a preferred embodiment, the user interface further comprises a search function associated with a web browser and a third virtual button placed in the header of the web browser. In a preferred embodiment the web browser is selected from the group consisting of Netscape, Internet Explorer, and Sofari. In another embodiment, the third virtual button is labeled “search the internet” such that when the third virtual button is clicked by a user the search engine will use the page displayed as a query to search the entire Internet database.

The invention also provides a computer comprising the system disclosed herein and the user interface, wherein the algorithm further comprises the step of searching the Internet using a query chosen by a user.

The invention also provides a method for compressing a text-based database comprising unique identifiers, the method comprising the steps of: i) generating a table containing text; ii) assigning an identifier (ID) to each text in the table wherein the ID for each text in the table is assigned according to the space-usage of the text in the database, the space-usage calculated using the equation freq(text)*length(text); and iii) replacing the text in the table with the IDs in a list in ascending order, the steps resulting in a compressed database. In a preferred embodiment of the method, the ID is an integer selected from the group consisting of binary numbers and integer series. In another alternative, the method further comprises compression using a zip compression and decompression software program. The invention also provides a method for decompressing the compressed database, the method comprising the steps of i) replacing the ID in the list with the corresponding text, and ii) listing the text in a table, the steps resulting in a decompressed database.

The invention further provides a full-text query and search method comprising the compression method as disclosed herein further comprising the steps of i) storing the databases on a hard disk; and ii) loading the disc content into memory. In another embodiment the full-text query and search method further comprises the step of using various similarity matrices instead of identity mapping, wherein the similarity matrices define Infotoms and their synonyms, and further optionally providing a similarity coefficient between 0 and 1, wherein 0 means no similarity and 1 means identical.

In another embodiment the method for calculating the Shannon Information further comprises the step of clustering text using the Shannon information. In a preferred embodiment, the text is in format selected from the group consisting of a database and a list returned from a search.

The invention also provides the system herein disclosed and the method for calculating the Shannon Information further using Shannon Information for keyword based searches of a query having less than ten words wherein the algorithm comprises the constants selected from the group consisting of a damping coefficient constant α, where 0<=α<=1 and a damping location coefficient constant β, where 0<=β<=1, and wherein the total score is a function of the shared Infotoms, total query Infotom number K, and the frequency of each Infotom in the hit, and α and β. In a preferred embodiment, the display further comprises multiple segments for a hit and the segmentation determined according to the feature selected from the group consisting of a threshold feature wherein the segment has a hit to the query above that threshold, a separation distant feature wherein there is significant word separating the two segments, and at an anchor feature at or close to both the beginning and ending of the segment, wherein the anchor is a hit word.

In one alternative embodiment the system herein disclosed and the method for calculating the Shannon Information are used for screening junk electronic mail.

In another alternative embodiment the system herein disclosed and the method for calculating the Shannon Information are used for screening important electronic mail.

### BRIEF DESCRIPTION OF THE DRAWINGS

FIG. 1 illustrates how the hits are ranked according to overlapping infotoms in the query and the hit.

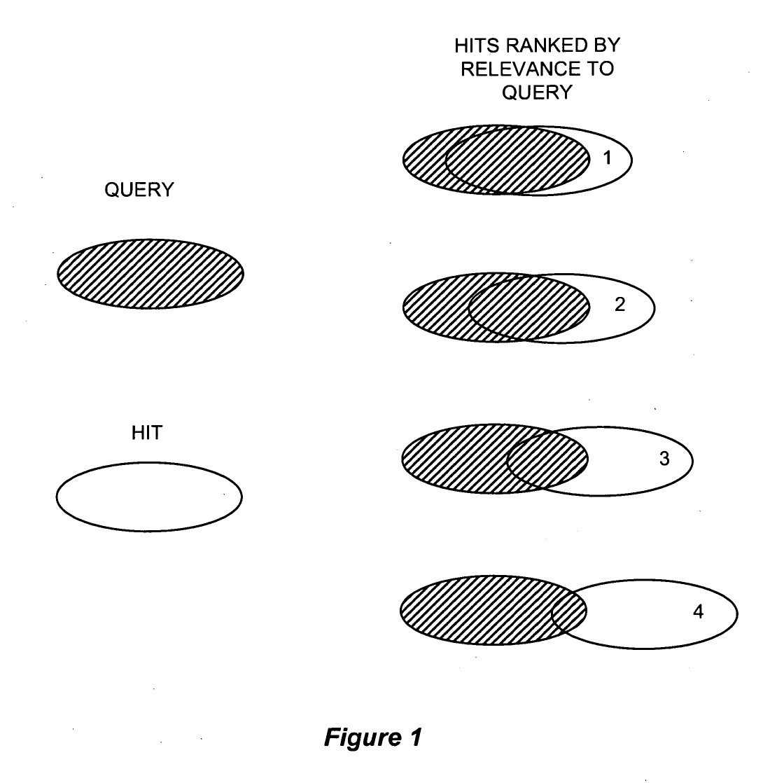

FIG. 2 is a schematic flow diagram showing how one exemplary embodiment of the invention is used.

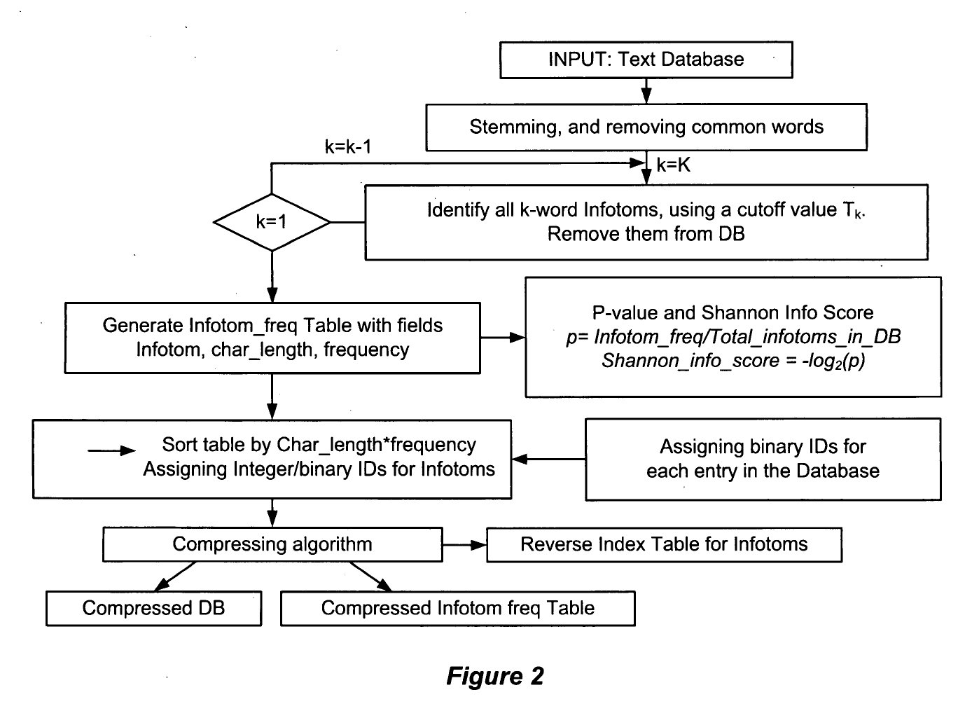

FIG. 3 is a schematic flow diagram showing how another exemplary embodiment of the invention is used.

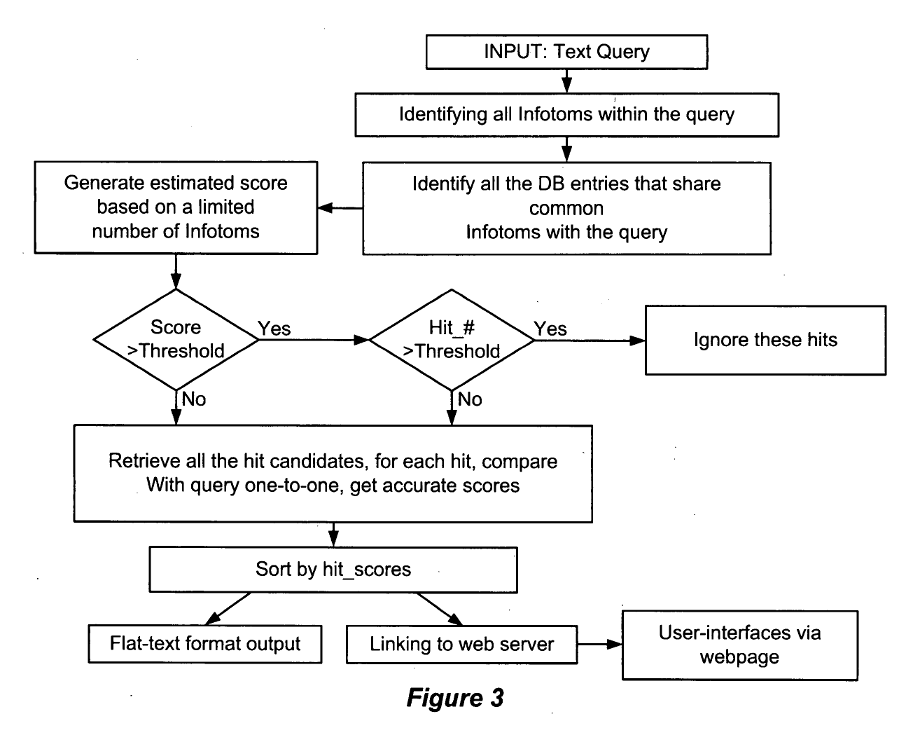

FIG. 4 illustrates an exemplary embodiment of the invention showing three different methods for query input.

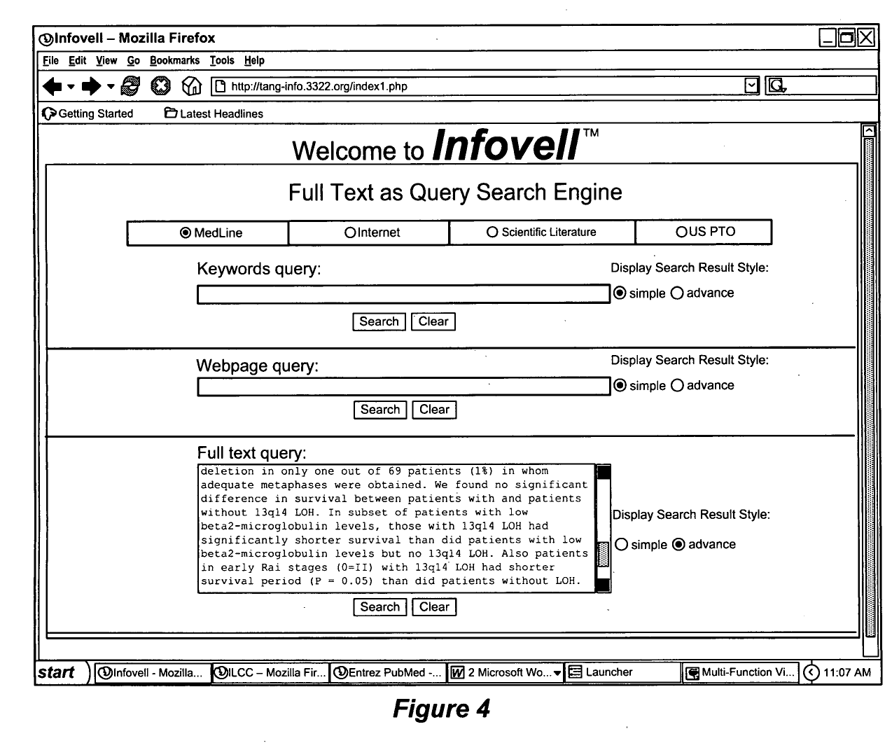

FIG. 5 illustrates an exemplary output display listing hits that were identified using the query text passage using the query of FIG. 4.

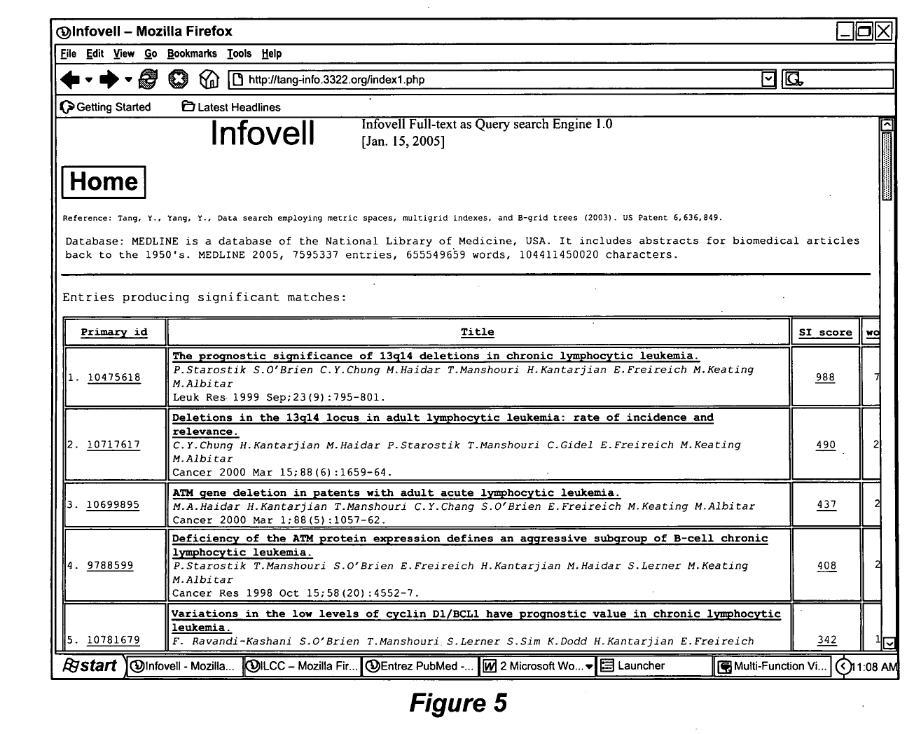

FIG. 6 illustrates a comparison between the query text passage and the hit text passage showing shared words, the comparison being accessed through a link in the output display of FIG. 5.

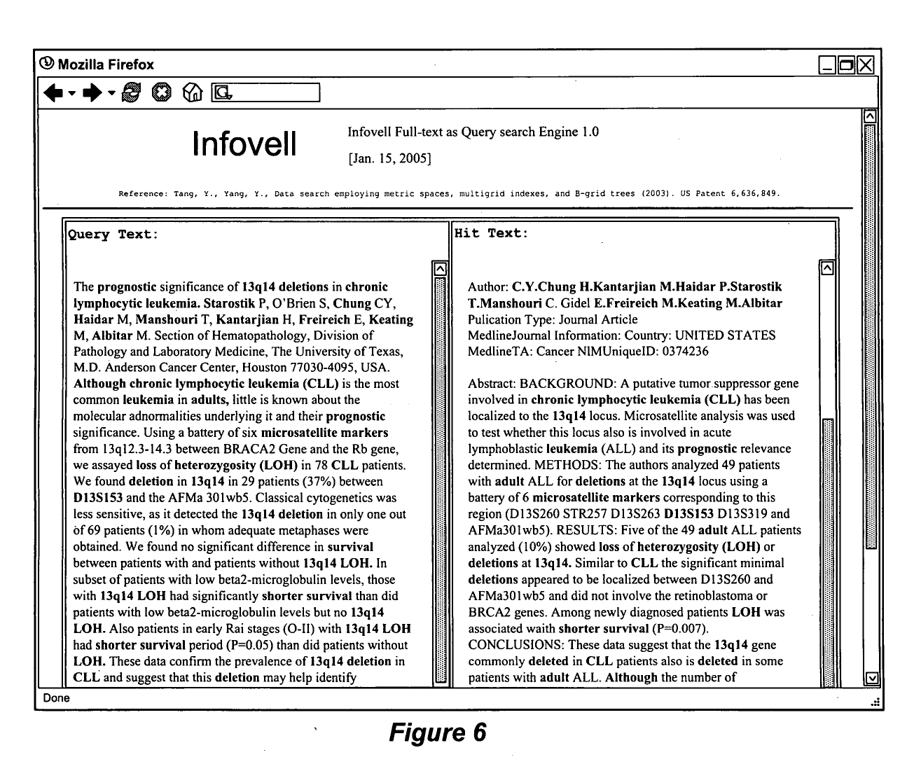

FIG. 7 illustrates a table showing the evaluated SI_score for individual words in the query text passage compared with the same words in the hit text passage, the table being accessed through a link in the output display of FIG. 5.

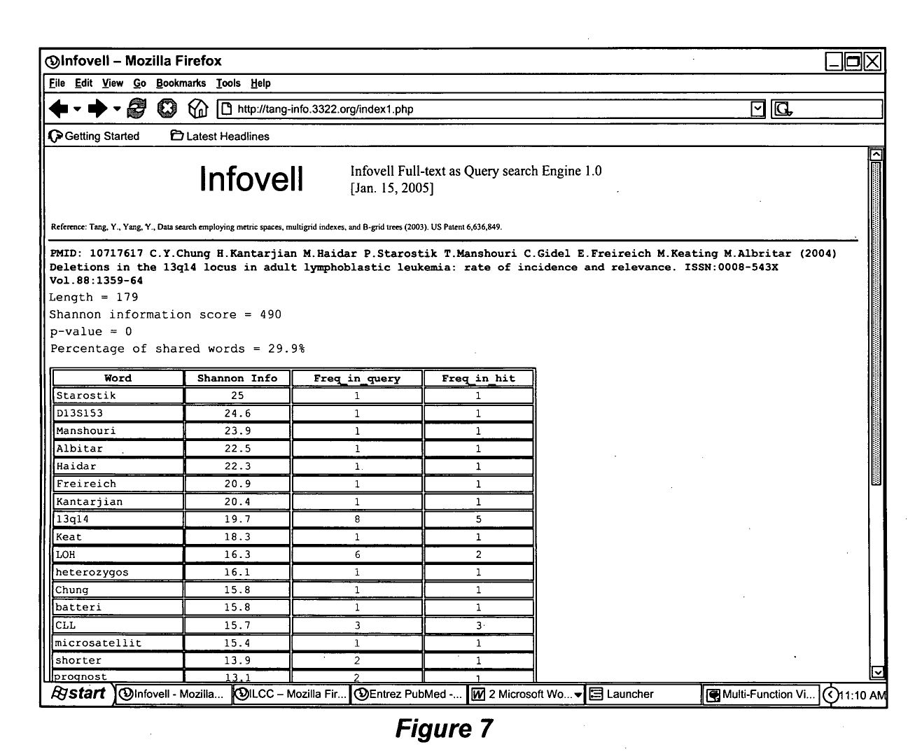

FIG. 8 illustrates the exemplary output display listing shown in FIG. 5 sorted by percentage identity.

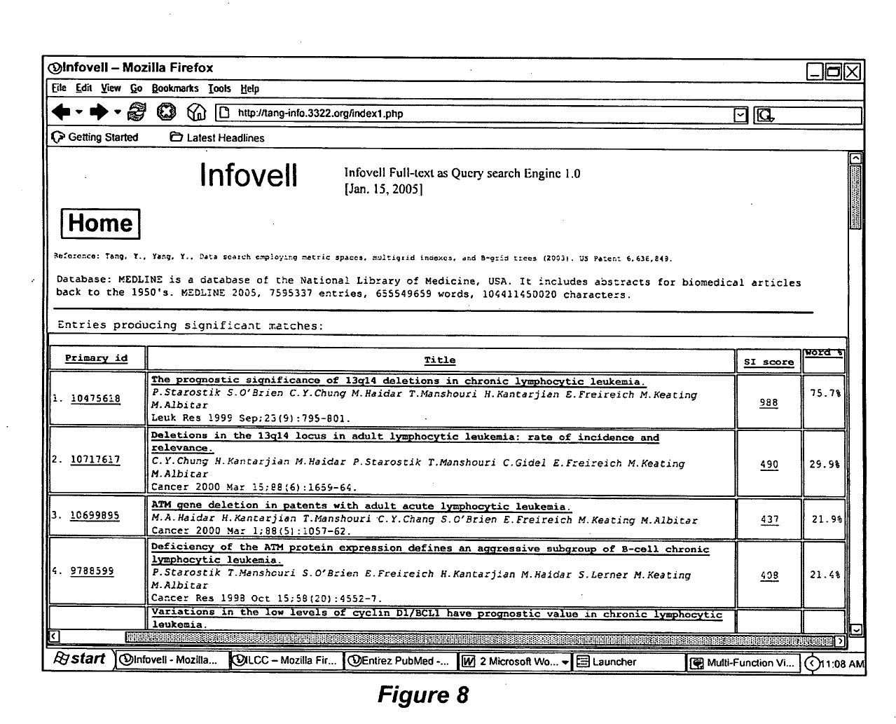

FIG. 9 illustrates an alternative exemplary embodiment of the invention showing three different methods for query input wherein the output displays a list of non-interactive hits sorted by SI_score.

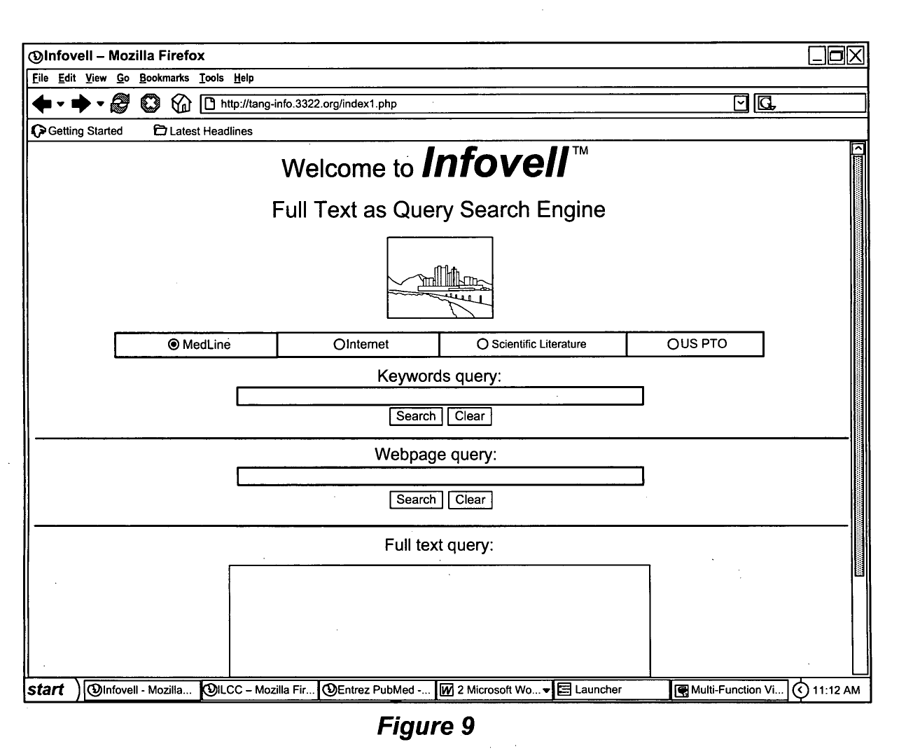

FIG. 10 illustrates an alternative exemplary embodiment of the invention showing one method for query input of a URL address that is then parsed and used as a query text passage.

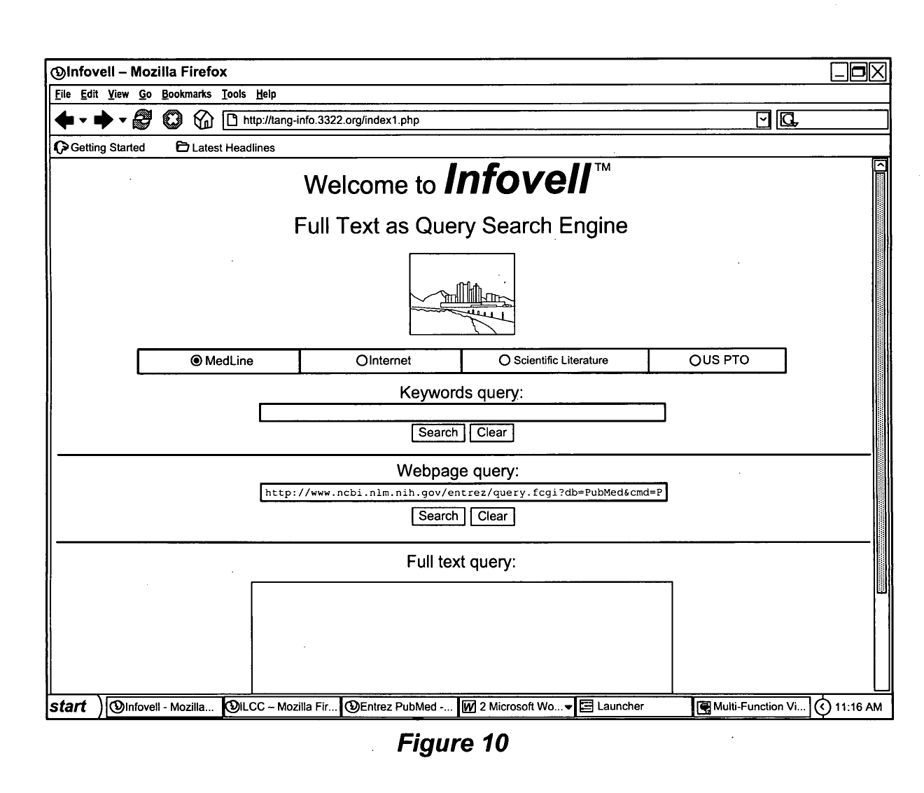

FIG. 11 illustrates the output using the exemplary URL of FIG. 10.

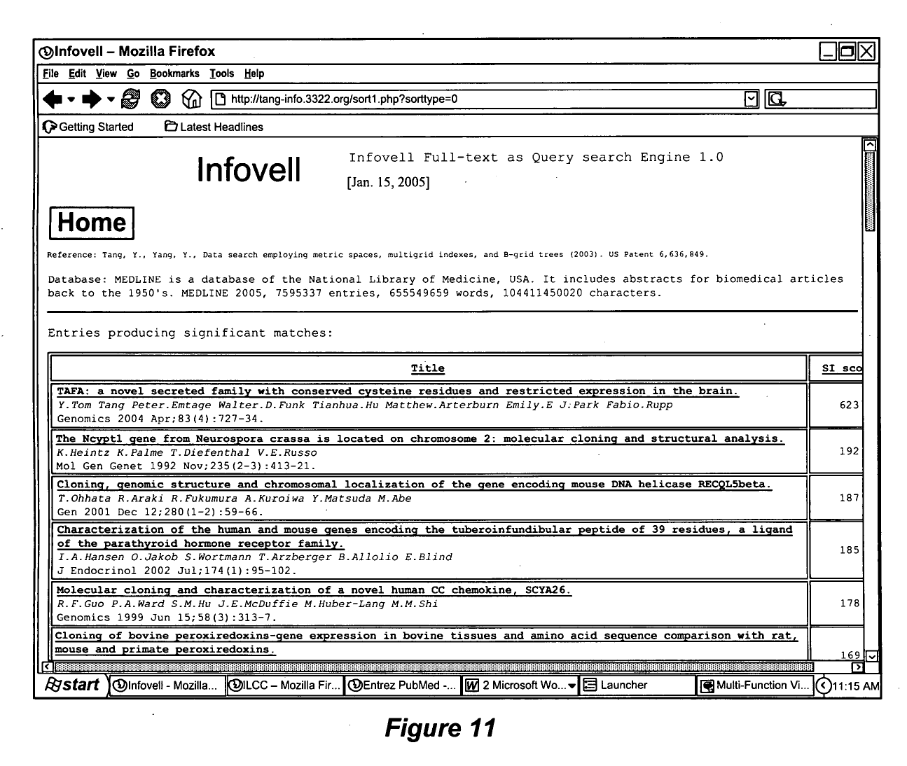

FIG. 12 illustrates an alternative exemplary embodiment of the invention showing one method for query input of a keyword string that is used as a query text passage.

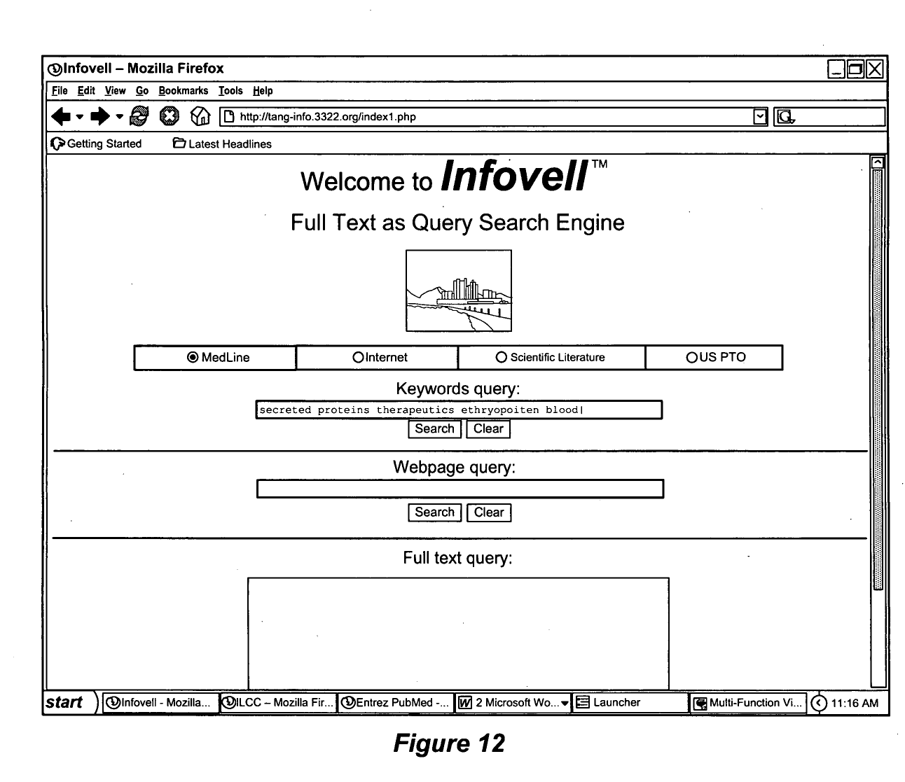

FIG. 13 illustrates the output using the exemplary keywords of FIG. 12.

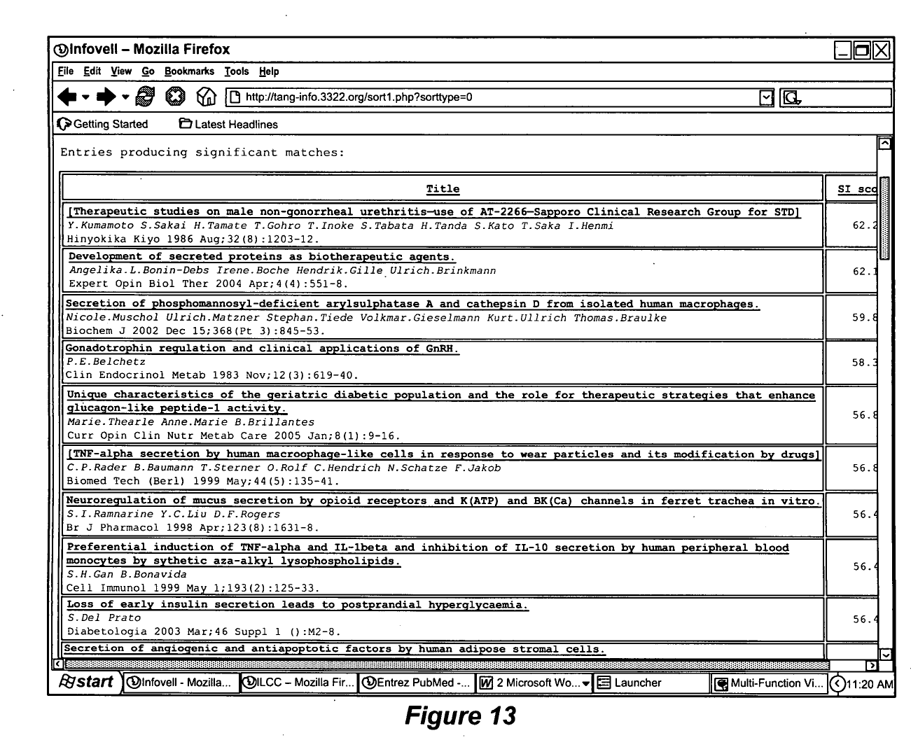

### MODES FOR CARRYING OUT THE INVENTION

The embodiments disclosed in this document are illustrative and exemplary and are not meant to limit the invention. Other embodiments can be utilized and structural changes can be made without departing from the scope of the claims of the present invention.

As used herein and in the appended claims, the singular forms “a,” “an,” and “the” include plural reference unless the context clearly dictates otherwise. Thus, for example, a reference to “a phrase” includes a plurality of such phrases, and a reference to “an algorithm” is a reference to one or more algorithms and equivalents thereof, and so forth.

### Definitions

Database and its entries: a database here is a text-based collection of individual text files. Each text file is an entry. Each entry has a unique primary key (the name of the entry). We expect the variance within the length of the entries not so large.

Query: a text file that contains information in the same category as in the database. Something that is of special interest to the user. It can also be an entry in the database.

Hit: a hit is a text file entry in the database where the overlap of query and the hit in the words used are calculated to be significant. Significance is associated with a score or multiple scores as disclosed below. When the overlapped words have a collective score above a certain threshold, it is considered to be a hit. There are various ways of calculating the score, for example, tracking the number of overlapped words; using cumulated Shannon Information associated with the overlapping word; calculating a p-value that indicates how likely that the hit associated with the query is due to chance.

Hit score: a measure (i.e. a metric) used to record the quality of a hit to a query. There are many ways of measuring this hit quality, depending on how the problem is viewed or considered. In the simplest scenario the score is defined as the number of overlapped words between the two texts. Thus, the more words are overlapped, the higher the score. The ranking by citation of the hit that appears in other sources and/or databases is another way. This method is best used in keyword searches, where 100% matches to the query is sufficient, and the sub-ranking of documents that contend the keywords is based on how important each website is. In the aforementioned case importance is defined as “citation to this site from external site”. In the search engine of the invention, the following hit scores can be used with the invention: percent identity, number of shared words and phrases, p-value, and Shannon Information. Other parameters can also be measured to obtain a score and these are well known to those in the art.

Word distribution of a database: for a text database, there is a total unique word count: N. Each word w has its frequency f(w), meaning the number of appearance within the database. The total number of words in the database is T_{w}=Sᵢ f(wᵢ),i=1, . . . , N, where Sᵢ means the summation over all i. The frequency for all the words w (a vector here), F(w), is termed the distribution of the database. This concept is from the probability theory. The word distribution can be used to automatically remove redundant phrases.

Duplicated word counting: If a word appears both once in query and in hit, it is easy to count it as a common word shared by the two documents. The invention contemplates accounting for a word that appears more than one time in both query and in hit? One embodiment will follow the following rules: for duplicated words in query (present m times) and in hit (present n times), the numbers are counted as: min (m, n), the smaller of m and n.

Percent identity: A score to measure the similarity between two files (query and hit). In one embodiment it is the percentage of words that are identical between the query file and the hit file. Percent identity is defined as: 2*number_of_shared_words)/(total_words_in_query+total_words_in_hit). For duplicated words in query and hit, we follow the rule in item 6. Usually, the higher the score, the more relevant are the two entries. If the query and the hit are identical, percent identity=100%.

p-value: the probability of the appearance of common words in the query and the hit that is purely by chance, given the distribution function F(w) for the database. This p-value is calculated using rigorous probability theory, but it is a little bit hard. As a first degree approximation, we will use p=pᵢp(wᵢ), where pᵢ is the multiplication over all i's for the words shared in the hit and query, and p(wᵢ) is the probability of each word, p(wᵢ)=f(wᵢ)/T. The real p-value is linearly correlated to this number but has a multiplication factor that is related to the size of query, the hit, and the database.

Shannon Information for a word: In more complex scenarios, the score can be defined as the cumulated Shannon Information of the overlapped words, where the Shannon Information is defined as −log₂(f/T_{w}) where f is the frequency of the word, the number of appearances of the word within the database, and T_{w} is the total number of words in the database.

Phrase means a list of words in a fixed consecutive order and is selected from a text and/or database using an algorithm that determines its frequency of appearing in the database (word distribution).

Infotom is the basic unit of information associated with a word, phrase, and/or text, both in a query and in a database. The word, phrase, and/or text in the database is assigned a word distribution frequency value and is assigned an Infotom if the frequency value is above a predefined frequency. The predetermined frequency can differ between databases and can be based upon the different content of the databases, for example, the content of a gene database is different to the content of a database of Chinese literature, or the like. The predetermined frequency for different databases can be summarized and listed in a frequency table. The table can be freely available to a user or available upon payment of a fee. The frequency of distribution of the Infotom is used to generate the Shannon Information and the p value. If the query and the hit have an overlapping and/or similar Infotom frequency the hit is assigned a hit score value that ranks it towards or at the top of the output list. In some cases, the term “word” is synonymous with the term “Infotom”; in other cases the term “phrase” is synonymous with the term “Infotom”.

Shannon entropy and information for an article or shared words between two articles Let X be a discrete random variable on a set x={x₁, . . . , xₙ}, with probability p(x)=Pr(X=x). The entropy of X, H(X), is defined as:

H(X)=−Sᵢp(xᵢ) log₂ p(xᵢ)

Where Sᵢ defines the summation over all i. The convention 0 log₂ 0=0 is adopted in the definition. The logarithm is usually taken to the base 2. When applied to the text search problem, the X is our article, or the shared words between two articles (with the each word having a probability from the dictionary), the probability can be the frequency of words in the database or estimated frequency. The information within the text (or the intersection of two texts): I(X)=−Sᵢ log₂ (xᵢ).

### Outline of Global Similarity Search Engine

We propose a new approach towards search engine technology that we call “Global Similarity Search”. Instead of trying to match keywords one by one, we look at the search problem from another perspective: the global perspective. Here, the match of one or two keywords is not essential anymore. What matters is the overall similarity between a query and its hit. The similarity measure is based on Shannon Information entropy, a concept that measures the information amount of each word or phrase.

1) No limitation on number of words. In fact, users are encouraged to write down whatever is wanted. The more words in a query, the better. Thus, in the search engine of the invention, the query may be a few keywords, an abstract, a paragraph, a full-text article, or a webpage. In other words, the search engine will allow “full-text query”, where the query is not limited to a few words, but can be the complete content of a text file. The user is encouraged to be specific about what they are seeking. The more detailed they can be, the more accurate information they will be able to retrieve. A user is no longer burdened with picking keywords.

2) No limit on database content, not limited to Internet. As the search engine is not dependent on link number, the technology is not limited by the database type, so long it is text-based. Thus, it can be any text content, such as hard-disk files, emails, scientific literature, legal collections, or the like. It is language independent as well.

3) Huge database size is a good thing. In a global similarity search, the number of hits is usually very limited if the user can be specific about what is wanted. The more specific one is about the query, the less hits will be returned. Huge size in database is actually a good thing to the invention, as it is more likely to find records a user wants. In keyword-based searches, large database size is a negative factor, as the number of records containing the few keywords is usually very large.

4) No language barrier. The technology applies to any language (even to alien languages if someday we receive them). The search engine is based on information theory, and not on semantics. It does not require any understanding on the content. The search engine can be adapted to any existing language in the world with little effort.

5) Most importantly, what the user wants is what the user gets and the returned hits are non-biased. A new scoring system is herewith introduced that is based on Shannon Information Theory. For example, the word “the” and the phrase “search engine” carries different amount of information. Information amount of each word and phrase is intrinsic to the database it is in. The hits are ranked by the amount of information in the overlapping words and phrases between the query and the hits. In this way, the most relevant entries within the database to the query are generally expected with high certainty to score the highest. This ranking is purely based on the science of Information Theory and has nothing to do with link number, webpage popularity, or advertisement fees. Thus, the new ranking is really objective.

Our angle of improving user search experience is quite different from other search engines such as provided by YAHOO or GOOGLE. Traditional search engines, including YAHOO and GOOGLE, are more concerned with a word, or a short list of words or phrases, whereas we are solving the problem of a larger text with many words and phrases. Thus, we present an entirely different way of finding and ranking hits. Ranking the hits that contain all the query words is not the top priority but is still performed in this context, as this rarely occurs for long queries, that is, queries having many words or multiple phrases. In the case that there are many hits, all containing the query words, we recommend the user refining their search by providing more description. This allows the search engine of the invention to better filter out irrelevant hits.

Our main concern is the method to rank hits with different overlaps with the query. How should they be ranked? The solution herein provided has its root in the “informational theory” developed by Shannon for communication. Shannon's Information concept is applied to text databases with given discrete distributions. Information amount of each word or phrase is determined by its frequency within the database. We use the total amount of information in shared words and phrases between the two articles to measure the relevancy of a hit. Entries in the whole database can be ranked this way, with the most relevant entry having the highest score.

### Language-Independent Technology Having Origins in Computational Biology

The search engine of the invention is language-independent. It can be applied to any language, including non-human languages, such as the genetic sequence databases. It is not related to semantics study at all. Most of the technology was first developed in computational biology for genetic sequence databases. We simply applied it to the text database search problem with the introduction of Shannon Information concepts. Genetic database search is a mature technology that has been developed by many scientists for over 25 years. It is one of the main technologies that achieved the sequencing of human genome, and the discovery of the ˜30,000 human genes.

In computational biology, a typical sequence search problem is as following: given a protein database ProtDB, and a query protein sequence ProtQ, find all the sequences in ProtDB that are related to ProtQ, and rank all them based on how close they are to ProtQ. Translating that problem into a textual database setting: for a given text database TextDB, and a query text TextQ, find all the entries in TextDB that are related to TextQ, and rank them based how close they are to TextQ. The computational biology problem is well-defined mathematically, and the solution can be found precisely without any ambiguity using various algorithms (Smith-Waterman, for example). Our mirrored text database search problem has a precise mathematical interpretation and solution as well.

For any given textual database, irrespective of its language or data content, the search engine of the invention will automatically build a dictionary of words and phrases, and assign Shannon information amount to each word and phrase. Thus, a query has its amount of information; an entry in the database has its amount of information; and the database has its total information amount. The relevancy of each database entry to the query is measured by the total amount of information in overlapped words and phrases between a hit and a query. Thus, if a query and an entry have no overlapped words/phrases the score will be 0. If the database contains the query itself, it will have the highest score possible. The output becomes a list of hits ranked according to their informational relevancy to the query. An alignment between query and each hit can be provided, where all the shared words and phrases can be highlighted with distinct colors; and the Shannon information amount for each overlapped word/phrases can also be listed. The algorithm used herein for the ranking is quantitative, precise, and completely objective.

Language can be in any format and can be a natural language such as, but not limited to Chinese, French, Japanese, German, English, Irish, Russian, Spanish, Italian, Portuguese, Greek, Polish, Czech, Slovak, Serbo-Croat, Romanian, Albanian, Turkish, Hebrew, Arabic, Hindi, Urdu, Thai, Togalog, Polynesian, Korean, Viet, Laosian, Kmer, Burmese, Indonesian, Swedish, Norwegian, Danish, Icelandic, Finnish, and Hungarian. The language can be a computer language, such as, but not limited to C/C++/C#, JAVA, SQL, PERL, and PHP. Furthermore, the language can be encrypted and can be found in the database and used as a query. In the case of an encrypted language, it is not necessary to know the meaning of the content to use the invention.

Words can be in any format, including letters, numbers, binary code, symbols, glyphs, hieroglyphs, and the like, including those existing but as yet unknown to man.

### Defining a Unique Measuring Matrix

Typically in the prior art the hit and the query are required to share the same exact words/phrases. This is called exact match, or “identity mapping”. But this is not necessary in the search engine of the invention. In one practice, we allow a user to define a table of synonyms. These query words/phrases with synonyms will be extended to search the synonyms in the database as well. In another practice, we allow users to perform “true similarity” searches by loading various “similarity matrices.” These similarity matrices provide lists of words that have similar meaning, and assign a similarity score between them. For example, the word “similarity” has a 100% score to “similarity”, but may have a 50% score to “homology”. The source of such “similarity matrices” can be from usage statistics or from various dictionaries. People working in different areas may prefer using a specific “similarity matrix”. Defining “similarity matrix” is an active area in our research.

### Building the Database and the Dictionary

The entry is parsed into words contained, and passed through a filter to: 1) remove uninformative common words such as “a”, “the”, “of”, etc., and 2) use stemming to merge the words with similar meaning into a single word, e.g. “history” and “historical”, “evolution”, “evolutionary”, etc. All words with the same stem are merged into a single word. Typographical errors, rare-word, and/or non-word may be excluded as well, depending on the utility of the database and search engine.

The database is composed of parsed entries. A dictionary is built for the database where all the words appeared in the database are collected. The dictionary also contains the frequency information of each word. The word frequency is constantly updated as the database expands. The database is also constantly updated by new entries. If a new word not in the dictionary is seen, then it is entered into the dictionary with a frequency equal to one (1). The information content of each word within the database is calculated based on

−log₂ (x), where the x is the distribution frequency (frequency of the word divided by total frequency of all words within the dictionary). The entire table of words and its associated frequency for a database is called a “Frequency Distribution”.

In the database each entry is reduced and/or converted to a vector in this very large space of the dictionary. The entries for specific applications can be further simplified. For instance, if only the “presence” or “non-presence” of a word within an entry is desired to be evaluated by the user, the relevant entry can be reduced into a recorded stream of just values of ‘1s’, and ‘0s’. Thus, an article is reduced to a vector. An alternative to this is to record word frequency as well, that is, the number of appearance of a word is also recorded. Thus, if “history” appeared ten times in the article, it will be represented as value ‘10’ in the corresponding column of the vector. The column vector can be reduced to a sorted, linked list, where only the serial number of the word and its frequency is recorded.

### Calculating Shannon Information Scores

Each entry has its own Shannon Information score that is the summary of all the Shannon Information (SI) for the words contained. In comparing two entries, all the shared words between the two entries are first identified. The Shannon Information for each shared word based on the Shannon Information of each word is calculated and the repetition times of this word in the query and in the hit. If a word appeared ‘m’ times in query, and ‘n’ times in hit, the SI associated with the word is:

SI_total(w)=min(n,m)*SI(w).

Another way to calculate the SI(w) for repeated words is to use damping, meaning that the amount of information calculated will be reduced by a certain proportion when it appeared in the 2^{nd} time, 3^{rd} time, etc. For example, if a word is repeated ‘n’ times, damping can be calculated as follows:

SI_total (w)=Si(α**(i−1))*SI(w)

where α is a constant, called the damping coefficient; Si is the summation over all i, 0<i<=n, 0<=α<=1. When α=0, it becomes SI(w), that is, 100% damping, and when α=1 it becomes n*SI(w), that is, no damping at all. This parameter can be set by a user at the user interface. Damping is especially useful in keyword-based searches, when entries containing more keywords are favored against entries that contain fewer keywords but repeated multiple times.

In keyword search cases, we introduce another parameter, called damping location coefficient, β, 0<=β<=1. β is used to balance the relevant importance of each keyword when keywords are appearing multiple times in a hit. β is used to assign a temporary Shannon_Info for a repeated word. If we have K word, we can set the SI for the first repeated word at the SI(int (β*K)), where SI(i) stands for the Shannon_Info for the i-word.

In keyword searches, these two coefficients (α, β) should be used together. For example, let α=0.75 and β=0.75. In this example, numbers in parentheses are simulated SI scores for each word. If one search results with
TAFA (20) Tang (18) secreted (12) hormone (9) protein (5)
then, when TAFA appeared in second time, its SI will be 0.75* SI(hormone)=0.75*9. If TAFA appears a 3^{rd} time, it will be 0.75*0.75*9. Now, let us assume that TAFA appeared a total of 3 times. The total ranking of words by SI are now
TAFA (20) Tang (18) secreted (12) hormone (9) TAFA (6.75) TAFA (5.06) protein (5).

If Tang appears a second time, its SI will be 75% of the number, number int(0.75*7)=5, which is TAFA(6.75). Thus, its SI is: 5.06. Now, with a total of 8 words in the hit, the scores (and ranking) are
TAFA (20) Tang (18) secreted (12) hormone (9) TAFA (6.75) TAFA (5.06) Tang (5.06) protein (5).

One can see that the SI for repeated word has a dependency on the spectrum of SI on all the words in the query.

### Heuristics of Implementation

1) Sorting the Search Results from a Traditional Search Engine.
If a traditional search engine returns a large number of results, where most of the results may not be what the user wants. If the user finds one article (A*) is exactly what he wants, he can now re-sort the search result into a list according to the relevance to that article using our full-text searching method. In this way, one only need to compare each of those articles once with A*, and resort the list according to the relevance to A*.

This application can be “stand-alone” software and/or one that can be associated with any existing search engine.

2) Generating a Candidate File List Using other Search Engines
As a way to implement our full text query and search engine, we can use a few keywords from the query (those words that are selected based on their relative rarity), and use the traditionally keyword based search engine to generate a list of candidate articles. As one example, we can use the top ten most informational words (as defined by the dictionary and the Shannon Information) as queries and use the traditional search engine to generate candidate files. Then we can use the sorting method mentioned above to re-order the search output, so that the most relevant to the query will appear the first.

Thus, if the algorithm herein disclosed is combined with any existing search engine, we can implement a method that will generate our results using another search engine. The invention can generate the correct query to other search engines and re-sort them in an intelligent way.

3) Screening Electronic Mail
The search engine can be used to screen an electronic mail database for “junk” mail. A “junk” mail database can be created using mail that has been received by a user and which the user considers to be “junk”; when an electronic mail is received by the user and/or the user's electronic mail provider, it is searched against the “junk” mail database. If the hit is above a predetermined and/or assigned Shannon Information score or p-value or percent identity, it is classified as a “junk” mail, and assigned a distinct flag or put into a separate folder for review or deletion.

The search engine can be used to screen an electronic mail database to identify “important” mail. A database using electronic mail having content “important” to a user is created, and when a mail comes in, it is searched against the “important” mail database. If the hit is above a certain Shannon Information score or p-value or percent identity, it is classified as an important mail and assigned a distinct flag or put into a separate folder for review or deletion.

Table 1 shows the advantages that the disclosed invention (global similarity search engine) has over current keyword-based search engines including YAHOO and GOOGLE search engines

TABLE 1

| | Global similarity search | Current keyword-based |
|---|---|---|
| Features | engine | search engines |
| Query type | Full text and key words | Key words (burdened |
| | | with word selection) |
| Query length | No limitation of number | Limited |
| | of words | |
| Ranking system | Non-biased, based on | Biased, for example, |
| | weighted information | popularity, links, etc., |
| | overlaps | so may lose real results |
| Result relevance | More relevant results | More irrelevant results |
| Non-internet content | Effective in search | Ineffective in search |
| databases | | |

The invention will be more readily understood by reference to the following examples, which are included merely for purposes of illustration of certain aspects and embodiments of the present invention and not as limitations.

### EXAMPLES

### Example I

### Implementation of the Theoretical Model

In this section details of an exemplary implementation of the search engine of the invention are disclosed.

1. Introduction to FlatDB Programs
FlatDB is a group of C programs that handles flat-file databases. Namely, they are tools that can handle flat text files with large data contents. The file format can be many different kinds, for example, table format, XML format, FASTA format, and any format so long that there is a unique primary key. The typical applications include large sequence databases (genpept, dbEST), the assembled human genome or other genomic database, PubMed, Medline, etc.

Within the tool set, there is an indexing program, a retrieving program, an insertion program, an updating program, and a deletion program. In addition, for very large entries, there is a program to retrieve a specific segment of entries. Unlike SQL, FlatDB does not support relationship among different files. For example, if all the files are large table files, FlatDB cannot support foreign key constraints on any table.

Here is a list of each program and a brief description on its function:
1. im_index: for a given text file where a field separator exists and primary_id is specified, im_index generates an index file (for example <text·db>) which records each entry, where they appear in the text, and the size of the entry. The index file is sorted.
2. im_retrieve: for a given database (with index), and a primary_id (or a list of primary_ids in a given file), the program retrieves all the entries from the text database.
3. im_subseq: for a given entry (specified by a primary_id) and a location and size for that entry, im_subseq returns the specific segment of that entry.
4. im_insert: it inserts one or a list of entries into the database and updates the index. While it is inserting, it generates a lock file so others cannot insert contents the same time.
5. im_delete: deletes one or multiple entries specified by a file.
6. im_update: updates one or multiple entries specified by a file. It actually runs an im_delete followed by an im_insert.

The most commonly used programs are im_index, im_retrieve. im_subseq is very useful if one needs to get a subsequence from a large entry, for example, a gene segment inside a human chromosome.

In summary, we have written a few C programs that are flat-file database tools. Namely they are tools that can handle a flat-file with many data contents. There is an indexing program, a retrieving program, an insertion program, an updating program, and a deletion program.

2. Building and Updating a Word Frequency Dictionary
Name: im_word_freq<text_file><word_freq>
Input:
   1: a long list of text file. Flat text file is in FASTA format (as defined below).
   2: a dictionary with word frequency.
Output: updating Input 2 to generate a dictionary of all the word used and the frequency of each word.
Language: PERL.
Description:
   1. The program first reads Input_{—}2 into memory (a hash: word_freq): word_freq {word}=freq.
   2. It opens file <text_file>. For each entry, it splits the file into an array @entry_one), each word is a component of $entry_one. For each word, word_freq{word}+=1.
   3. Write the output into <word_freq.new>.
FASTA format is a convenient way of generating large text files (used commonly in listing large sequence data file in biology). It typically looks like:

>primary_id1 xxxxxx(called annotation)
text file (with many new lines).
>primary_id2

The primary_ids should be unique, but otherwise, the content is arbitrary.

3. Generating a Word Index for a Flat-File FASTA Formatted Database
Name: im_word_index <text_file><word_{word}_freq>
Input:
   1. a long list of text file. Flat text file in FASTA format (as defined above).
   2. a dictionary with word frequency associated with the text_file.
Output:
   1. two index files: one for the primary_ids, one for the bin_ids.
   2. word-binary_id association index file.
Language: PERL.
Description: The purpose for this program is for a given word, one will be able to quickly identify which entries contain this word. In order to do that, we need an index file, essentially for each word in the word_freq file, we have to list all the entries that contain this word.
Because the primary_id is usually long, we want to use a short form. Thus we assign a binary id (bin_id) to each primary_id. We then need a mapping file to associate quickly between the primary_id and the binary_id. The first index file in the format: primary_id bin_id, sorted by the primary_id. And the other is: bin_id primary_id, sorted by the primary_id. These two files are for look up purpose: namely given a binary_id one can quickly find what its primary_id, and vice versa.
The final index file is the association between the words in the dictionary, and a list of binary_ids that this word appears. The list should be sorted by bin_ids. The format can be FASTA, for example:

>Word1, freq.
bin_id1 bin_id2 bin_id3 ....
>Word2, freq
bin_id1 bin_id2 bin_id3, bin_id3....

4. Finding All the Database Entries that Contains a Specific Word
Name: im_word_hits <database><word>
Input
   1: a long list of text file. Flat text file in FASTA format, and its associated 3 index files.
   2: a word.
Output
   A list of bin_ids (entries in the database) that contain the word.
Language: PERL.
Description: For a given word, one wants to quickly identify which entries contain this word. In the output, we have a list all the entries that contain this word.
Algorithm: for the given word, first use the third index file to get all the binary_ids of texts containing this word. (One can use the second index file: binary_id to primary_id to get all the primary_ids). One returns the list of binary_ids.
This program should also be available in as a subroutine: im-word hits (text file, word).

5. For a Given Query, Find All the Entries that Share Words With the Query
Name: im_query_{—}2 hits <database_file><query_file>[query_word_number] [share_word_number]
Input
   1: database: a long list of text file. Flat text file in FASTA format.
   2: a query in FASTA file that is just like the many entries in the database.
   3: total number of selected words to search, optional, default 10.
   4: number of words in the hits that are in the selected query words, optional, default 1.
Output: list of all the candidate files that share a certain number of words with the query.
Language: PERL.
Description: The purpose for this program is for a given query, one wants a list of candidate entries that share at least one word (from a list of high information words) with the query.
We first parse the query into a list of words. We then look up the word_freq table to establish query_word_number (10 for default, but user can modify) words with the lowest frequency (that is, highest information content). For each of the 10 words, we use the im_word hits (subroutine) to locate all the binary_ids that contain the word. We merge all those binary_ids, and also count how many times the binary_id appeared. We only keep those binary_ids that have >share_word_number of words (at least share one word, but can be 2 if there are too many hits).
We can sort here based on a hit_score for each entry if the total number of hit number is >1000. The calculation of hit_score for each entry is to use the Shannon Information for the 10 words. This hit_score can also be weighted by the frequency of each word in both the query and the hit file.
Query_word_number is a parameter that users can modify. If larger, the search will be more accurate, but it may take longer time. If it is too small, we may loss accuracy.

6. For Two Given Text Files (Database Entries), Compare and Assign a Score
Name: im_align_{—}2 <word_freq><entry_{—}1><entry_{—}2>
Input:
   1: The word_frequency file generated for the database.
   2: entry_{—}1: a single text file. One database entry in FASTA format.
   3: entry_{—}2: same as entry_{—}1.
Output: A number of hit scores including: Shannon Information, Common word numbers. The format is:
   1) Summary: entry_{—}1 entry_{—}2 Shannon_Info_score Common_word_score.
   2) Detailed Listing: list of common words, the database frequency of the words, and the frequency within entry_{—}1 and in entry_{—}2 (3 columns).
Language: C/C++.
This step will be the bottleneck in searching speed. That is why we should write it in C/C++. In prototyping, one can use PERL as well.
Description: For two given text files, this program compares them, and assign a number of scores that describes the similarity between the two texts.
The two text files are first parsed into to arrays of words @text1, and @text2). A join operation is performed between the two arrays to find the common words. If the common words are null, return NO COMMON WORDS BETWEEN entry_{—}1 and entry_{—}2 to STDERR.
If there are common words, the frequency of each common word is looked up in word freq_file. Then, the Sum of all Shannon Information for each shared word is calculated. We generate a SI_score here (for Shannon Information). The total number of words in the common words (Cw_score) is also counted. There may be more scores to report in the future (such as the correlation between the two files including the frequency comparisons of the words, and normalization based on the text length, etc.).
To calculate Shannon Information, refer to the original document on the method (Shannon (1948) Bell Syst. Tech. J., 27: 379-423, 623-656; and see also Feinstein (1958) Foundations of Information Theory, McGraw Hill, New York N.Y.).

7. For a Given Query, Rank All the Hits
Name: im_rant_hits <database_file><query_file><query_hits>
Input:
   1: database: a long list of text file. Flat text file in FASTA format.
   2: a query in FASTA file. Just like the many entries in the database.
   3: a file containing a list of bin_ids that are in the Database.
Options:
   1 [rank_by] default: SI_score. Alternative: CW_score.
   2. [hits] number of hits to report. Default: 300.
   3. [min_SI_score]: to be determined in the future.
   4. [min_CW_score]: to be determined in the future.
Output: a sorted list of all the files in the query_hits based on hit scores.
Language: C/C++/PERL.
This step is the bottleneck in searching speed. That is why it should be written in C/C++. In prototyping, one can use PERL as well.
Description: The purpose for this program is for a given query and its hits, one wants to rank all those hits based on a scoring system. The scoring here is a global score, showing how related the two files are.
The program first calls the im_align_{—}2 subroutine to generate a comparison between the query and each of the hit_file. It then sorts all the hits based on the SI_score. A one-line summary is generated for each hit. This summary is listed in the beginning of the output. In the later section of the output, the detailed alignment of common words and frequency of those words are shown for each hit.
The user should be able to specify the number of hits to report. Default is 300. The user also can specify sort order, default is SI_score.

### Example II

A Database Example for MedLine.

Here is a list of database files as they were processed:

1) Medline·raw Raw database downloaded from NLM, in XML format.

2) Medline·fasta Processed database
FASTA Format for the parsed entries follows the format

>primary_id authors.(year) title. Journal. volume:page-page
word1(freq) word2(freq) ...

words are be sorted by character.

3) Medline·pid2bid Mapping between primary_id (pid) and binary_id (pid).
Medline·bid2pid Mapping between binary_id and primary_id
Primary_id is defined in the FASTA file. It is the unique identifier used by Medline. Binary_id is an assigned id used for our own purpose to save space.
Medline·pid2bid is a table format file. Format: primary_id binary_id (sorted by primary_id).
Medline·bid2pid is a table format file. Format: binary_id primary_id (sorted by binary_id)

4) Medline·freq Word frequency file for all the word in Medline·fasta, and their frequency. Table format file: word frequency.

5) Medline·freq·stat Statistics concerning Medline·fasta (database size, total word counts, Medline release version, release dates, raw database size. Also has additional information concerning the database.

6) Medline·rev Reverse list (word to binary_id) for each word in the Medline·freq file.

7) im_query_{—}2_hits <db><query·fasta>
Here both database and query are in FASTA format. Database is: /data/Medline·fasta. Query is ANY entry from Medline·fasta, or anything from the web. In the later case, the parser should convert any format of user-provided file into a FASTA formatted file confirming to the standard specified in Item 2.

The output from this program should be a List_file of Primary_Id and Raw_scores. If the current output is a list of Binary_ids, it can be eitherly transformed to Primary_ids by running: im_retrieve Medline·bid2pid <bid_list> > pid_list.

On generating the candidates, here is a re-phrasing of what was discussed above:

1) Calculate an ES-score (Estimated Shannon score) based on the top ten words query (10-word list) which has lowest frequency in the frequency-dictionary of database.

2) ES-score should be calculated for all the files. A putative hit is defined by:
(a) Hits 2 words in the 10-word list.
(b) Hit THE word, the highest Shannon-score for the words in the query. In this way, we don't miss any hit that can UNIQUELY DEFINE A HIT in the database.

Rank all the a) and b) hits by ES-score, and limit the total number up to 0.1% of database size (for example, 14,000 for a db of 14,000,000). (If the union of (a) and (b) is less than 0.1% of database size, the rank does not have to be performed, simply pass the list as done; this will save time).

3) Calculate the Estimated_Score using the formulae disclosed below in item 8, except in this case there are at most ten words.

8) im_rank_hits <Medline·fasta><query.fasta><pid_list>

The first thing the program does is to run: im_retrieve Medline·fasta pid_list and store all the candidate hits in memory before starting the 1-1 comparison of query to each hit file.

Summary: Each of the database file mentioned above (Medline·*) should be indexed using im_index. Please don't forget to specify the format of each file in running im_index.

If temporary files to hold your retrieved contents are desired, put them in /tmp/directory. Please use the convention of $$.* to name your temporary files, where $$ is your process_id. Remove these temp files generated at a later time. Also, no permanent files should be placed in/tmp.

Formulae for Calculating the Scores:
p-value: the probability that the common word list between the query and the hit is completely due to a random event.

Let T_{w} be total number of words (for example, SUM (word*word_freq)) from the word freq table for the database (this number should be calculated be written in the header of the file: Medline·freq·stat. One should read that file to get the number. For each dictionary word (w[i]) in the query, the frequency in the database is f_{d}[i]. The probability of this word is: p[i]=f_{d}[i]/T_{w}.

Let the frequency w[i] in the query be f_{q}[i], and frequency in the hit be fₕ[i], f_{c}[i]=min(f_{q}[i], fₕ[i]). f_{c}[i] is the smaller number of frequency in the query and hit. Let m be the total common words in the query, i=1, . . . , m, p-value is calculated by:

p=(S₁f_{c}[i]! (p_{—}i p[i]**f_{c}[i])/(p_{—}f_{c}[i]!)

where Sᵢ is the summation of all i (i=1, . . . , m), and p_i means the multiplication of all i, (i=1, . . . , m),! is the factorial (for example, 4!=4*3*2*1)

p should be a very small number. Ensure that floating type is used to do the calculation. SI_score (Shannon Information score) is the −log₂ of p-value.

3. word_% (#_shared_words/total_words). If a word appears multiple times, it is counted multiple times. For example: query (100 words), hit (120 words), shared words 50, then word_%=50*2/(100+120).

### Example III

### Method for Generating a Dictionary of Phrases

1. Theoretical Aspects of Phrase Searches
Phrase searching is when a search is performed using a string of words (instead of a single word). For example: one might be looking for information on teenage abortions. Each one of these words has a different meaning when standing alone and will retrieve many irrelevant documents, but when you one them together the meaning changes to the very precise concept of “teenage abortions”. From this perspective, phrases contain more information than the single words combined.

In order to perform phrase searches, we need first to generate phrase dictionary, and a distribution function for any given database, just like we have them for single words. Here a programmatic way of generating a phrase distribution for any given text database is disclosed. From purely a theoretical point of view, for any 2-words, 3-words, . . . , K-words, by going through the complete database the occurring frequency of each “phrase candidate” are obtained, meaning they are potential phrases. A cutoff is used to only select those candidates with frequency that is above a certain threshold. The threshold for a 2-word phrase many be higher than that for a 3-word phrase, etc. Thus, once the thresholds are given, the phrase distribution for 2-word, . . . , K-word phrases are generated automatically.

Suppose we already have the frequency distribution for 2-word phrases F(w2), 3-word phrases F(w3), . . . , where w2 means all the 2-word phrases, and w3 all the 3-word phrases. We can assign Shannon Information for phrase wk (a k-word phrase):

SI(wk)=−log₂ f(wk)/T_{wk}

where f(wk) is the frequency of the phrase, and T_{wk} is the total number of phrases within the distribution F(wk).

Alternatively, we can have a single distribution for all phrases, irrespective of the phrase length, we call this distribution F(wa). This approach is less favored compared to the first, as we usually think a longer phrase would contain more information compare to a shorter phrase, even they occurred the same number of times within the database.

When a query is given, just like the way we generate a list of all words, we can generate a list of all potential phrases (up to K-word). We can then look at the phrase dictionary to see if any of them are real phrases. We select those phrases within the database for further search.

Now we assume there exists a reverse dictionary for phrases as well. Namely for each phrase, all the entries in the database containing this phrase is listed in the reverse dictionary. Thus, for the given phrases in the query, using the reverse dictionary we can find out which entries contain these phrases. Just as we handle words, we can calculate the cumulative score for each entry which contain at lease one of the query phrases.

In the final stage of summarizing the hit, we can use alternative methods. The first method is to use two columns, one for reporting word score, and the other for reporting phrase score. The default will be to report all hits ranked by cumulative Shannon Information for the overlapped words, but with the cumulative Shannon Information for the phrases in the next column. The user can also select to use the phrase SI score to sort the hits by clicking the column header.

In another way, we can combine the SI-score for phrases with that of SI for the overlapped words. Here there is a very important issue: how should we compare the SI-score for words with the SI-score for phrases. Even within the phrases, as we mentioned above, how we compare the SI-score for a 2-word phrase vs. a 3-word phrase? In practice, we can simply using a series of factors to merge the various SI-scores together, that is,:

SI_total=SI_word+a₂*SI_{—}2-word-phrase+. . . +aₖ*SI_{—}K-word-phrase

where aₖ, k=2, . . . , K are coefficients that are >=1, and are monotonic increasing.

If the consideration of adjusting for phrase length is already taken care in the generation of a single phrase distribution function F(wa), then, we have a simpler formulae:

SI_total=SI_word+a*SI_phrase

where a is a coefficient: a>=1. a reflects the weighting between word score and phrase score.

This method of calculation of Shannon Information is applicable to either a complete text (that is, how much total information a text has within the setting of a given distribution F, or to the overlapped segments (words and phrases) between a query and a hit.

2. Medline Database and Method of Automated Phrase Generation

Program 1: phrase_dict_generator

1). Define 2 hashes:
CandiHash: a hash of single word that may serve as a component of a Phrase.
PhraseHash: a hash to record all the discovered Phrases and their frequencies.
Define 3 parameters:
WORD_FREQ_MIN=300
WORD_FREQ_MAX=1000000
PHRASE_FREQ_MIN=100

2). From the word freq table, take all the words with frequency>=WORD_FREQ_MIN, and <=WORD_FREQ_MAX. Read them into The CandiHash.

3). Take the Medline·stem file (if this file has preserved the word orders in the original file, otherwise you have to regenarate a Medline·stem file such that the word order in the original file is preserved).

Psuedo code:

```
while (<Medline.stem>) {
    foreach entry {
      Read in 2 words a time, shift 1 word a time
      check if both words are in CandiHash, if yes:
        PhraseHash{word1_word2}++;
  }
}
```

4). Loop step 2 until 1) the end of Medline·stem or 2) system close to Memory_Limit.
If 2) write PhraseHash, clear PhraseHash, contines while(<Medline·stem>) until END OF Medline·stem

5). If multiple outputs from step 4, merge_sort the outputs >Medline·phrase·freq·0.
If finishes with condition 1), sort PhraseHash>Medline·phrase·freq.0.

6). Any thing in Medline·phrase·freq·0 with frequency >PHRASE_FREQ_MIN is a phrase. Sort all those entries into: Medline·phrase·freq.

Program 2. phrase_db_generator

```
  1). Read in Medline.phrase.freq into a Hash: PhraseHash_n
  2). while (<Medline.stem>) {
foreach entry {
  Read in 2 words a time, shift 1 word a time
  Join the 2 words, and check if it is defined in the PhraseHash_n
  if yes {
    write Medline.phrase for this entry}
  }
}
```

Program 3·phrase_revdb_generator
This program generates Medline·phrase·rev. It is generated the same as the reverse dictionary for words. For each phrase, this file contains an entry that lists all the binary ids of all database entries that contain this phrase.

### Example IV

### Command-Line Search Engine for Local Installation

A stand-alone version of the search engine is developed. This version does not have the web interface. It is composed of many programs mentioned before and compiled together. There is a single Makefile. When “make install” is typed, the system compiles all the programs within that directory, and generate three main programs that are used. The three programs are:

1) Indexing an Database:
im_index_all: all program that generates a number of indexes, including the word/phrase frequency tables, and the forward and reverse indexes. For example:
   S im_index_all /path/to/some_db_file_base·fasta

2) Starting the Searching Server:
im_GSSE_server: this program is the server program. It loads all the indexes into memory and keeps running on the background. It handles the service requests from the client: im_GSSE_client. For example:
   $ im_GSSE_server/path/to/some_db_file_base·fasta

3) Run Search Client
Once the server is running, one can run a search client to perform the actual searching. The client can be run locally on the same machine, or remotely from a client machine. For example:
   $ im_GSSE_client_qf /path/to/some_query·fasta

### Example V

### Compression Method for Text Database

The compression method outlined here is for the purpose of shrinking the size of the database, save the usage of hard disk and system memory, and to increase the performance of computer. It is also an independent method that can be applied to any text-based database. It can be used alone for compression purpose, or it can be combined with current existing compression techniques such as zip/gzip etc.

The basic idea is to locate the words/phrases of high frequency, and replace these words/phrases with shorter symbols (integers in our case, called code hereafter). The compressed database is composed of a list of words/phrases, and their codes, and the database itself with the words/phrases replaced with code systematically. A separate program reads in the compressed data file and restores it to original text file.

Here is the outline of how the compression method works:

During the process of generating all the word/phrase frequency, assign a unique code to each word/phrase. The mapping relationship between the word/phrase and its code is stored in a mapping file, with the format: “word/phrase, frequency, code”. This table was generated from a table with “word/phrase, frequency” only, and the table was sorted by the reverse order of length(word/phrase)*frequency. The code is assigned to this table from row 1 to the bottom sequentially. In our case the code is an integer starting at 1. Before the compression, all the existing integers in the database have to be protected by using a non-text character in its front.

Those skilled in the art will appreciate that various adaptations and modifications of the just-described embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention can be practiced other than as specifically described herein. The above description is intended to be illustrative, and not restrictive. Many other embodiments will be apparent to those of skill in the art upon reviewing the above description. The scope of the invention should, therefore, be determined with reference to the appended claims, along with the full scope of the disclosed invention to which such claims are entitled.

1-28. (canceled)

29. A data processing system comprising
1) a database of string entries,
2) a routine for processing the string entries, the routine selected from the group consisting of calculating a frequency distribution of string entries, associating an external frequency distribution with string entries in the database, and associating an external probability distribution with a collection of string entries in the database,
and 3) a routine for analyzing the database using the distribution.

30. The data processing system of claim 29 wherein the routine for analyzing the database is selected from the group consisting of searching the database, querying the database, clustering the content of the database, and classifying the content of the database.

31. The data processing system of claim 30 wherein a search query is selected from the group consisting of a keyword, a plurality of keywords, a title, an abstract, a full text query, a webpage, a webpage URL address, a highlighted segment of a webpage, and any part thereof.

32. The data processing system of claim 29 further comprising a routine for calculating an information measure using the distribution.

33. The data processing system of claim 32, wherein the information measure comprises a negative log of the frequency or a negative log of the probability.

34. The data processing system of claim 29, wherein a string associated with the distribution defines an Infotom, the string comprising contiguous digitized text, the digitized text selected from the group consisting of letters, spaces, numbers, keywords, binary code, symbols, glyphs, and hieroglyphs.

35. The data processing system of claim 32, wherein the information measure is calculated using a Shannon information function.
